(19) United States
(12) Patent Application Publication
(10) Pub. No.: US 2006/0119881 A1
(43) Pub. Date: Jun. 8, 2006

(54) Methods and apparatus for managing configuration of an imaging device peripheral

(76) Inventor: Maria Fernanda Zarco, Boise, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/005,189

(22) Filed: Dec. 4, 2004

(51) Int. Cl. G06F 3/12

(52) U.S. Cl. 358/1.15

(57) ABSTRACT

A system and method is directed to operating an imaging device to configure an imaging device peripheral. The method includes detecting at least one imaging device peripheral, determining if the at least one detected imaging device peripheral has been configured, requesting configuration data that enables the imaging device peripheral to operate with the imaging device from a configuration service provider when the at least one detected imaging device peripheral has not been configured, receiving the configuration data from the configuration service provider, and configuring the imaging device peripheral for operation with the imaging device based on the received configuration data.

### BACKGROUND

Imaging device peripherals are devices designed to be operably coupled to an imaging device and provide added functionality to the imaging device. Conventional imaging device peripherals may incorporate several functions such as stapling, hole punching, sheet folding, stitching-binding, sorting, collating, etc.

Typically, imaging device peripherals may be required to interface with many different imaging device models. Unfortunately, interfacing imaging device peripherals with all potential imaging device models requires a large amount of manufacturer/designer resource allocation to insure proper functionality of the imaging device peripherals. For example, serious conflicts may occur when new features are added to existing imaging device peripherals that are interfaced with older imaging device models. Conventional practice generally requires that every upgrade to each imaging device peripheral be communicated to all imaging device models to prevent conflicts, whether or not the imaging device utilizes the new feature. The resources required to provide these new features to imaging device peripherals and imaging device models can be enormous.

It would be desirable therefore, to provide advancements to the art that overcome these and other disadvantages.

### SUMMARY

According to an embodiment of the present invention, a method is directed to operating an imaging device to configure an imaging device peripheral. The method includes detecting at least one imaging device peripheral, and determining if the at least one detected imaging device peripheral has been configured. The method further includes requesting configuration data, which enables the imaging device peripheral to operate with the imaging device, from a configuration service provider when the detected imaging device peripheral has not been configured. The method additionally includes receiving the configuration data from the configuration service provider, and configuring the imaging device peripheral for operation with the imaging device based on the received configuration data.

According to another embodiment, a method is directed to configuring an imaging device peripheral to operate with an imaging device that includes receiving an identification request, which includes a request for device specific identification data and a configuration status, to the imaging device peripheral from the imaging device. The method further includes providing the device specific identification data and the configuration status to the imaging device and receiving configuration data, which enables the imaging device peripheral to operate with the imaging device, to the imaging device peripheral from the imaging device when the configuration status indicates that the imaging device peripheral has not been configured. The method additionally includes configuring the imaging device peripheral for operation with the imaging device based on the received configuration data.

According to yet another embodiment, a network configured to provide resource management includes an imaging device which includes a communication interface, an imaging device peripheral, a processor, and a computer readable memory device which is readable by the processor. The computer readable memory device contains a series of computer executable steps configured to cause the processor to detect at least one imaging device peripheral, and to determine if the at least one detected imaging device peripheral has been configured. The computer executable steps are configured to cause the processor to request configuration data that enables the imaging device peripheral to operate with the imaging device from a configuration service provider when the at least one detected imaging device peripheral has not been configured, to receive the configuration data from the configuration service provider, and finally to configure the imaging device peripheral for operation with the imaging device based on the received configuration data.

The foregoing, and other features and advantages of the invention, will become further apparent from the following detailed description of the presently preferred embodiments, read in conjunction with the accompanying drawings.

### DESCRIPTION OF THE DRAWINGS

FIG. 1 is a block diagram of a networked resource management system, illustrating an exemplary operating environment for one embodiment of the present invention;

FIG. 2 is a block diagram of a networked imaging device, illustrating another embodiment of the present invention;

FIG. 3 is a flow diagram depicting a method of operating an imaging device to configure an imaging device peripheral, in accordance with another embodiment of the present invention; and

FIG. 4 is a flow diagram depicting a method of configuring an imaging device peripheral to operate with an imaging device, in accordance with yet another embodiment of the present invention.

### DETAILED DESCRIPTION

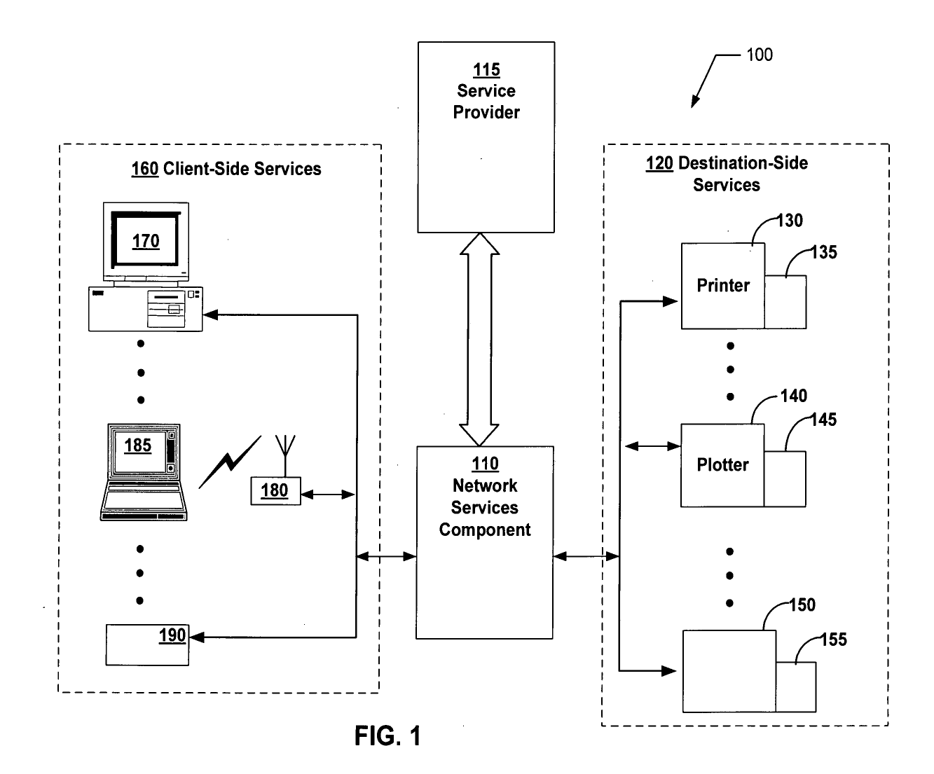

FIG. 1 illustrates a networked resource management system in an exemplary operating environment. FIG. 1 illustrates a networked resource management system 100 for managing data flow within a network. Networked resource management system 100 includes network services component 110, service provider 115, destination-side services 120, and client-side services 160. Destination-side services 120 further includes a printer 130 operably coupled to printer peripheral 135, a plotter 140 operably coupled to plotter peripheral 145, and additional destination-side services component 150 operably coupled to component peripheral 155. Client-side services 160 includes a personal computer (PC) 170, a wireless hub 180 in wireless communication with a laptop computer 185, and additional client-side services component 190. Networked resource management system 100 is a distributed node network wherein components within the network are addressable devices attached to the network.

Network services component 110 is coupled to destination-side services 120, client-side services 160, and service provider 115, and performs routing functions for resource management system 100. In one embodiment, a server computer (not specifically shown) having network services software implements the functions of network services component 110. In this embodiment, the server computer (not specifically shown) having network services software includes a communications bus, at least one processor, a computer readable memory device which is readable by the processor, and other such components as are necessary to provide network services component functionality. In another embodiment, the capabilities and functions of network services component 110 are distributed among one or more connected devices (not shown). In another embodiment, the capabilities and functions of network services component 110 are performed by the individual components within client-side services 160.

Service provider 115 is operably coupled to network services component 110 so as to allow communication, where necessary, between components of resource management system 100. Service provider 115 includes one or more communication-enabled servers configured to provide information from a remote location. In one embodiment, service provider 115 provides information responsive to an information request.

Destination-side services 120 is coupled to network services component 110, provides device capabilities information to network services component 110, and receives and executes job requests from network services component 110. Destination-side components are devices having features and options that provide specified services, such as, for example printing, plotting, data file management, data storage, scanning, and computing services, such as, a server computer, personal computers, and the like.

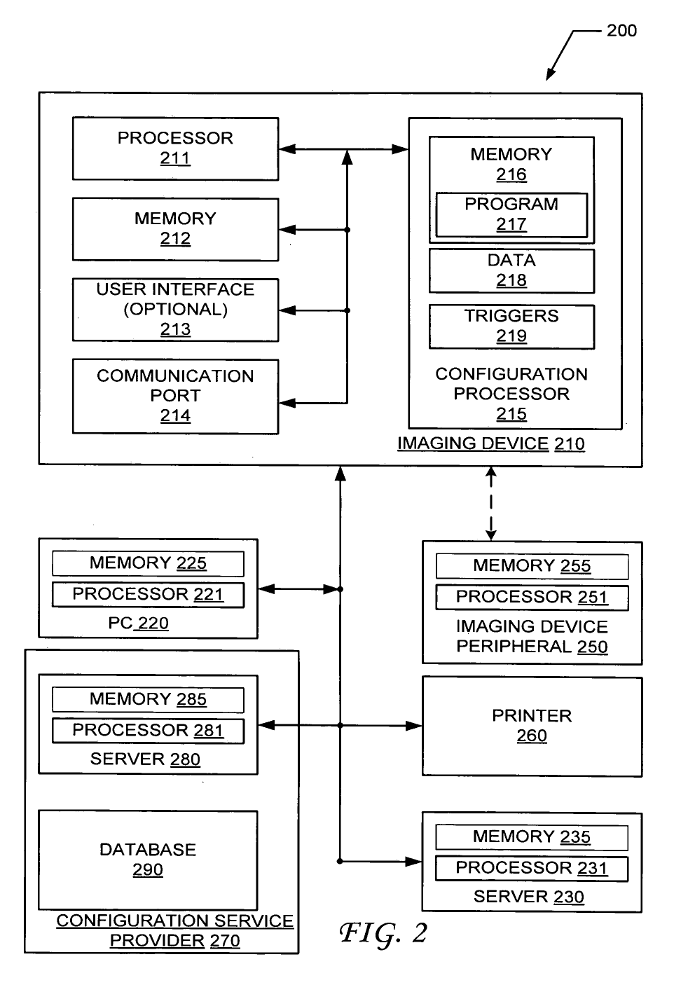

Printer 130 is any communication-enabled printing device configured for rendering images and documents, such as proof images, from data files onto tangible media, such as, for example, paper sheet stock. Printer peripheral 135 is any printing peripheral device operably coupled to printer 130 to perform services, such as, for example paper handling services. In one embodiment, printer 130 is a multi-function printer-scanner device enabled to operate as a document copying and sending device as well as a printing device. In another embodiment (not shown but described in FIG. 2, below), printer 130 includes a processor and memory components. In another embodiment, printer peripheral 135 is a paper handling peripheral, such as, for example a stapler, a hole punch, a stitching unit, a collator, a sorter, a sheet laminator, a sheet folder, etc.

Plotter 140 is any communication-enabled plotting device configured for rendering images from data files onto tangible media, such as, for example, paper sheet stock. Plotter peripheral 145 is any plotter peripheral device operably coupled to plotter 140 to perform services, such as, for example paper handling services. In one embodiment (not shown), plotter 140 includes a processor and memory components. In another embodiment, plotter peripheral 145 is a paper handling peripheral which can take various forms, as described above with respect to printer peripheral 135.

Additional destination-side services component 150 is any other destination-side services component, such as, for example a scanner, a computing services component, a facsimile machine, a digital sending device, and the like. Component peripheral 155 is any peripheral device operably coupled to destination-side services component 150 to perform services, such as, for example paper handling services. In one embodiment (not shown), additional destination-side services component 150 includes a processor and memory components to provide data file management or data storage, among numerous other functions. In another embodiment, component peripheral 155 is a paper handling peripheral, such as described above with respect to printer peripheral 135 and plotter peripheral 145.

Client-side services 160 is coupled to network services component 110, provides requests and information to network services component 110, and receives status updates and information from network services component 110. Client-side services 160 include client devices/components (described below) that provide a user interface presenting various features and options for implementation.

Personal computer (PC) 170 is any PC or laptop that is a communication-enabled computer system having a memory component and a processor (not shown). In one embodiment, the memory component includes programs and data (not shown) such as, for example, an operating system, as will be known to those skilled in the art. In another embodiment (not shown), the memory component includes data such as that stored to memory device, that is, programs to practice the client-side services portion of the invention. The skilled practitioner will recognize that in some implementations personal computer 170 includes other components not relevant to the present discussion, and therefore do not require elaboration.

Wireless hub 180 is any wireless communication-enabled hub including the requisite components to provide wireless coupling of laptop computer 185 to a network incorporating network services component 110. Laptop computer 185 is any laptop or personal computer that is a wireless communication-enabled computer system having a memory component and a processor (not shown). In one embodiment, the memory component includes programs and data (not shown) such as, for example, an operating system, as will be known to those skilled in the art. In another embodiment (not shown), the memory component includes data such as that stored to memory device, that is, programs to practice the client-side services portion of the invention. The skilled practitioner will recognize that in some implementations laptop computer 185 includes other components not relevant to the present discussion, and therefore do not require elaboration.

Additional client-side services component 190 is any other client-side services component, such as a network node coupled to an associated network, a scanner, a facsimile machine, a database including data files containing images, template data and send job data, and the like. In one embodiment (not shown), additional client-side services component 190 includes a processor and memory components to provide data file management or data storage, among numerous other functions.

In operation, a destination-side services 120 component detects that a peripheral has been operably coupled to the destination-side component, and determines if the peripheral has been configured to operate with the destination-side component. In one embodiment, if the peripheral has not been configured to operate with the destination-side component, the destination-side component requests configuration data from service provider 115 via network services component 110. In another embodiment, if the peripheral has not been configured to operate with the destination-side component, the destination-side component requests configuration data from a client-side services 160 component via network services component 110, such as, for example from a removable storage media accessed by a client-side services 160 component. The configuration data enables the peripheral to operate with the destination-side services 120 component. Further to the operation of networked resource management system 100, the destination-side services 120 component receives the configuration data and the peripheral is configured for operation with the destination-side services 120 component responsive to the receipt of the configuration data.

FIG. 2 is a block diagram of a networked resource management system, illustrating another embodiment of the present invention. FIG. 2 illustrates a configuration system 200 for operating an imaging device 210 to configure an imaging device peripheral. FIG. 2 shows an imaging device 210 in communication with a personal computer (PC) 220, a server 230, a printer 260, and a configuration service provider 270. Imaging device 210 is additionally in communication with an imaging device peripheral 250. In one embodiment, imaging device peripheral 250 is operably coupled to imaging device 210. Configuration system 200 can include additional components not relevant to the present discussion.

FIG. 2 also shows imaging device 210 as including a processor 211, a memory device 212, an optional user interface 213, a communication port 214, and a configuration processor 215. The configuration processor 215 is shown including a memory 216, configuration data 218, and triggers 219. Memory 216 further includes program 217. Processor 211 is further shown enabled for bidirectional communication with memory device 212, user interface 213, communication port 214, and configuration processor 215. Configuration processor 215 is further shown enabled for bidirectional communication with components of imaging device peripheral 250. Personal computer 220 is shown including memory 225 and a processor 221. Server computer 230 is also shown including memory 235 and a processor 231. Configuration service provider 270 is shown including a server 280 and a database 290. Server 280 includes a processor 281 and a memory device 285. Imaging device peripheral 250 includes a processor 251 and a memory device 255.

Imaging device 210 is shown enabled for bidirectional communication with various devices over a communication interface, including personal computer 220, server 230, printer 260, and a configuration service provider 270 through communication port 214. The depicted connections between imaging device 210 and other devices illustrate a network; that is, each device of configuration system 200 has a unique device identification and network address. Additionally, a device such as personal computer 220 or server computer 230 is enabled to access additional destination addresses such as, for example, e-mail addresses, that can be directly attributable to the unique identification of a device accessing the address, but nonetheless represent unique destinations.

Imaging device 210 is any device configurable for receiving digital images and image data from an electronically addressable destination, such as, for example, personal computer 220. In an embodiment, imaging device 210 is a digital receiving device such as a multi-function printer device, a plotter, a facsimile machine, a communication-enabled printing and scanning device, or a communication-enabled scanning device.

Processor 211 is any microprocessor, microcontroller, application-specific integrated circuit (ASIC), or combination of the recited components, configured to execute computer instructions. In an embodiment, processor 211 includes memory for caching data, and performing digital signal processing, such as, for example, image processing algorithms. Memory device 212 includes volatile or non-volatile computer readable memory, such as, for example, random access memory (RAM), flash memory and the like. In one embodiment, processor 211 is configured to execute instructions from one or more programs stored in memory 212, and to manipulate digital data.

Optional user interface 213 is an arrangement of data-entry and display devices configured to receive user input to imaging device 210. In one embodiment, user interface 213 includes an alphanumeric key pad and an alphanumeric display suitable for receiving and displaying email addresses, indicating a number of scanned images in a scan job and other data.

Communication port 214 includes one or more communication interfaces configured to provide signal and data input and output to imaging device 210. In an embodiment, communication port 214 includes interfaces such as, for example, a telephone modem, a wireless access point adhering to one or more protocols, such as IEEE 802.11 and the so-called “Bluetooth” protocols, a network interface card, a direct cable interface such as PCI or EIO, a Universal Serial Bus card (USB), an optical port operating in the ultra-violet or infra-red range, and the like. In another embodiment, communication port 214 is a gateway for a local area network (LAN) or a wide area network (WAN) that couples many devices within a geographic zone, such as for example, a business computer network operating within one or more buildings. A communication-enabled device is a device that incorporates a communication gateway, such as communication port 214, having one or more communication interfaces as described above.

Configuration processor 215 is any microprocessor, microcontroller, application-specific integrated circuit (ASIC), or combination of the recited components, configured to execute computer instructions. In one embodiment, processor 215 includes memory for caching data, and performing digital signal processing, such as, for example, image processing algorithms. Memory device 216 includes volatile or non-volatile computer readable memory, such as, for example, random access memory (RAM), flash memory and the like. In one embodiment, configuration processor 215 is configured to execute instructions from one or more programs 217 stored in memory 216, and to manipulate digital data stored in data 218 when initiated via a trigger stored in triggers 219. Program 217 includes one or more computer executable instruction sets that perform functions, such as, for example, operating imaging device 210 to configure an imaging device peripheral. In another embodiment, the functionality of configuration processor 215, memory 216, configuration data 218, triggers 219, and program 217 is accomplished by processor 211 and memory device 212 of imaging device 210.

Personal computer 220 is any communication-enabled computer system having a memory component 225 and a processor 221. In one embodiment, memory component 225 includes programs and data (not shown) such as, for example, an operating system, as will be known to those skilled in the art. In another embodiment (not shown), memory component 225 includes data such as that stored to memory device 216; that is, programs as well as data stored to a removable storage medium. The skilled practitioner will recognize that in some implementations personal computer 220 includes other components not relevant to the present discussion, and therefore do not require elaboration.

Server computer 230 is any communication-enabled computer system having a memory component 235 and a processor 231. In one embodiment, memory component 235 includes programs and data (not shown) such as, for example, server side programs, as will be known to those skilled in the art. The skilled practitioner will recognize that, in some implementations, server computer 230 includes other components not relevant to the present discussion that will therefore not be discussed.

Imaging device peripheral 250 is any communication-enabled peripheral operably coupled to imaging device 210 and having a memory component 255 and a processor 251. In one embodiment, memory component 255 includes programs and data (not shown) such as, enabling the peripheral to provide specific additional functionality to imaging device 210 for example, stapler functionality, sorting and collating functionality, sheet folding and laminating functionality, hole punch functionality, stitching functionality, stacking functionality, sheet feeding functionality, envelope feeding functionality, etc.

Printer 260 is any communication-enabled printing device configured for rendering images and documents, such as proof images, from data files onto tangible media, such as, for example, paper sheet stock. In an embodiment, printer 260 is a multi-function printer-scanner device enabled to operate as a document copying and sending device. In one embodiment (not shown), printer 260 includes a processor and memory components. In another embodiment, a digital sender can be designated by a network administrator to default to specific network connected printers for printing of proof image documents based on the destination printer's capabilities. In yet another embodiment, the digital sender is enabled to “browse” the network for printers having required printing capabilities, such as for example, oversize sheets or color printing. The configuration and operation of printing devices will be known to the skilled practitioner, and therefore will not be discussed in further detail.

In another embodiment, printer 260 includes a scanner (not shown), implemented as any communication-enabled scanning device configured to generate image files. In an example, the scanner portion of printer 260 includes digital, analog or both scanning hardware that is configured to create image data files of media that are located proximate to the scanning hardware. In another example (not shown), the scanner portion of printer 260 includes a processor and memory components. In yet another example, the scanner portion of printer 260 incorporates an alphanumeric keypad and an alphanumeric display. The configuration and operation of scanning devices will be known to the skilled practitioner, and therefore will not be discussed in further detail.

In still another embodiment, printer 260 includes a device having facsimile (fax) machine (not shown) capabilities. In an example (not shown), the facsimile capabilities portion of printer 260 includes a mechanism for digitally scanning documents, a processor, a communication port and one or more memory components. In another example, the facsimile capabilities portion of printer 260 is enabled to operate as a document copying device. The configuration and operation of facsimile machines and printer with facsimile capabilities is well known to those skilled in the art, and therefore will not be further discussed.

Configuration service provider 270 is any communication enabled computer system having a server component 280 and a database 290. Server component 280 is any communication-enabled computer system having a memory component 285 and a processor 281. In one embodiment, memory component 285 includes programs and data (not shown) such as, service-side programs for example, providing configuration data responsive to a configuration data request. The skilled practitioner will recognize that, in some implementations, server computer 280 includes other components not relevant to the present discussion. Database 290 is any communication-enabled mass storage device containing a database. In one embodiment, database 290 is a relational database having entries that correspond to specific addressable accounts, such as, for example an imaging device peripheral model number, email addresses, and the like. The skilled practitioner will recognize that, in some implementations, database 290 includes other components not relevant to the present discussion.

In operation, imaging device 210 detects imaging device peripheral 250 and determines if imaging device peripheral 250 has been configured. In one embodiment, the coupling of imaging device peripheral 250 to imaging device 210 produces a trigger at triggers 219, thereby causing configuration processor 215 to run a configuration program stored at memory 216. In the event that imaging device peripheral 250 has not been configured, the configuration program requests configuration data from a configuration data provider, for example, configuration service provider 270, a removable storage media within a communication-enabled computer system, such as, personal computer 220, and the like. The configuration data enables the imaging device peripheral to operate with the imaging device. Configuration processor 215 receives the configuration data from the configuration data provider to configuration data 218. Imaging device peripheral 250 is then configured responsive to the reception of the configuration data.

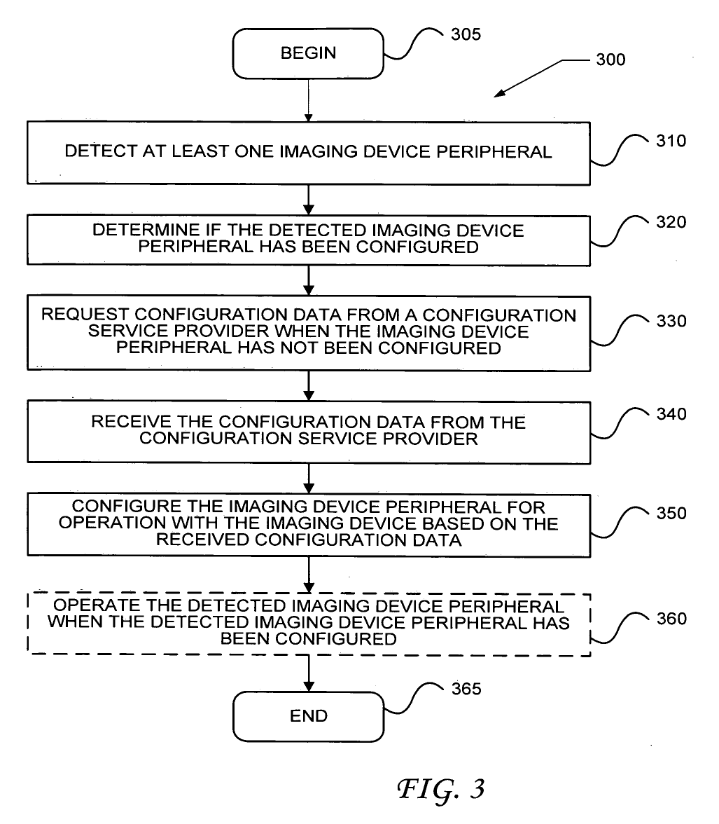

FIG. 3 is a flow diagram depicting a method 300, in accordance with another embodiment of the present invention. FIG. 3 illustrates a method 300 of operating an imaging device to configure an imaging device peripheral. In one embodiment, method 300 is implemented with components of the exemplary system of FIG. 1 and the exemplary networked resource management system described with reference to FIG. 2. In another embodiment, one or more steps of method 300 are embodied in a computer readable medium containing computer readable code such that a series of steps are implemented when the computer readable code is executed on a computing device. Method 300 begins at step 305. Various steps of the method 300 are described with respect to an imaging device performing the method in conjunction with an imaging device peripheral. In some implementations, certain steps of method 300 are combined, performed simultaneously, or in a different order, without deviating from the objective of method 300 or producing different results.

At step 310, at least one imaging device peripheral is detected. In one embodiment, an imaging device detects at least one imaging device peripheral. In an example and referring to FIG. 1 above, printer 130 detects at least one printer peripheral 135. In another example and referring to FIG. 2 above, imaging device 210 detects at least one imaging device peripheral 250. In yet another example, the imaging device detects at least one imaging device peripheral and obtains imaging device peripheral identification, imaging device peripheral model number/serial number, imaging device peripheral features, and the like.

In another embodiment, the imaging device is implemented as any one of the following; a printer, a scanner, a multifunction printer/scanner, a plotter, a digital sending device, and a facsimile machine. In yet another embodiment, the imaging device peripheral is implemented as any one of the following; a stapler, a sorter, a collator, a hole punch, a laminator, a sheet folder, a stitching unit, a stacker, a sheet feeder (e.g., a fax input tray), an envelope feeder, etc.

At step 320 (FIG. 3), a determination is made as to whether the at least one detected imaging device peripheral has been configured. In one embodiment, when the imaging device peripheral is detected by the imaging device, the imaging device polls the imaging device peripheral to determine whether the imaging device peripheral is configured for operation with the imaging device and any other imaging device peripherals that are coupled to the imaging device. In an example and referring to FIG. 2 above, when the imaging device peripheral 250 is detected by the imaging device 210, configuration processor 215 of imaging device 210 polls processor 251 of imaging device peripheral 250 to determine whether imaging device peripheral 250 is configured for operation with imaging device 210 and any other imaging device peripherals (not shown) that are coupled to imaging device 210.

At step 330 (FIG. 3), configuration data from a configuration service provider is requested when the at least one detected imaging device peripheral has not been configured. The configuration data enables the imaging device peripheral to operate with the imaging device. In one embodiment, requesting configuration data from the configuration service provider when the detected imaging device peripheral has not been configured includes identifying the imaging device, and polling additional detected imaging device peripherals that have previously been configured for device specific identification data. The request for configuration data from the configuration service provider further includes producing a configuration data request based on the identified imaging device, the detected imaging device peripheral that has not been configured, and additional detected previously configured imaging device peripherals, and communicating the configuration data request to the configuration service provider.

In an example, and referring to FIG. 2 above, requesting configuration data from configuration service provider 270 when the detected imaging device peripheral 250 has not been configured includes identifying imaging device 210, and polling additional detected imaging device peripherals (not shown) that have previously been configured for device specific identification data. The request for configuration data from configuration service provider 270 further includes producing a configuration data request based on the identified imaging device 210, the detected imaging device peripheral 250 that has not been configured, and additional detected previously configured imaging device peripherals (not shown), and communicating the configuration data request to configuration service provider 270.

At step 340 (FIG. 3), the configuration data is received from the configuration service provider. In one embodiment, the configuration data is received to the imaging device from the configuration service provider. In an example and referring to FIG. 2 above, the configuration data is received to imaging device 210 from configuration service provider 270. In another embodiment, the configuration data is received to the imaging device from a configuration service provider via a network. In an example and referring to FIG. 1 above, the configuration data is received to printer 130 from service provider 115 via network services component 110.

At step 350, the imaging device peripheral is configured for operation with the imaging device, based on the received configuration data. In one embodiment, configuring the imaging device peripheral for operation with the imaging device based on the received configuration data includes providing the received configuration data to the imaging device peripheral, and implementing the configuration data within the imaging device peripheral. In an example and referring to FIG. 2 above, configuring imaging device peripheral 250 for operation with imaging device 210 based on the received configuration data includes providing the received configuration data to imaging device peripheral 250, and implementing the configuration data within imaging device peripheral 250.

At optional step 360 (FIG. 3), the detected imaging device peripheral is operated when the detected imaging device peripheral has been configured. In one embodiment, and following step 320, the detected imaging device peripheral is operated when the detected imaging device peripheral is determined to have been previously configured. In another embodiment and following step 350, the detected imaging device peripheral is operated responsive to the previous configuration step.

At step 365, the method ends.

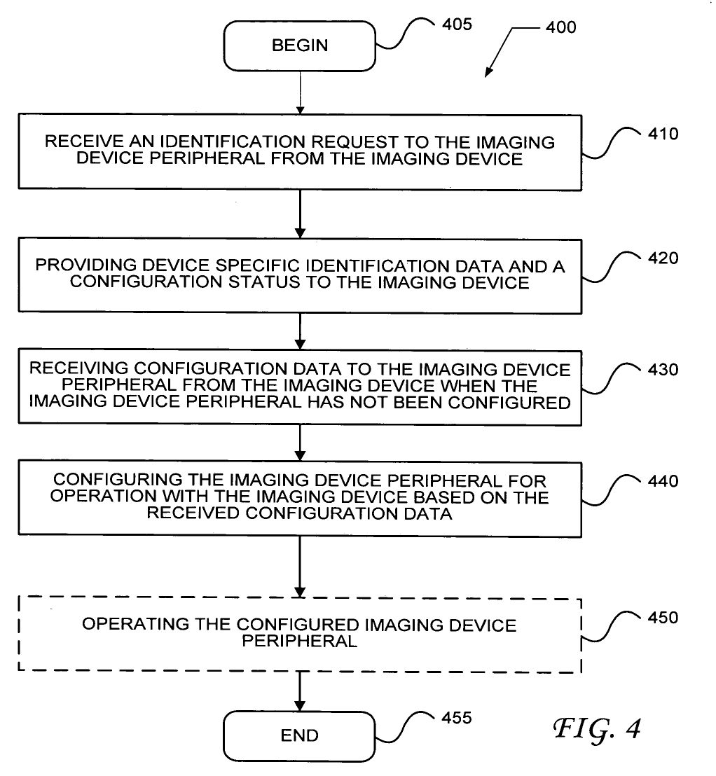

FIG. 4 is a flow diagram depicting a method, in accordance with yet another embodiment of the present invention. FIG. 4 illustrates a method 400 of configuring an imaging device peripheral to operate with an imaging device. In one embodiment, method 400 is implemented with components of the exemplary system of FIG. 1 and the exemplary networked resource management system described with reference to FIG. 2. In another embodiment, one or more steps of method 400 are embodied in a computer readable medium containing computer readable code such that a series of steps are implemented when the computer readable code is executed on a computing device. Method 400 begins in step 405. Various steps of the method 400 are described with respect to an imaging device peripheral performing the method in conjunction with an imaging device. In some implementations, certain steps of method 400 are combined, performed simultaneously, or in a different order, without deviating from the objective of method 400 or producing different results.

At step 410, an identification request is received to the imaging device peripheral from the imaging device. The identification request includes a request for device specific identification data and a configuration status of the imaging device peripheral. In an example and referring to FIG. 1 above, printer peripheral 135 receives a request from printer 130. In another example and referring to FIG. 2 above, imaging device peripheral 250 receives a request from imaging device 210.

In another embodiment, the imaging device is implemented as any one of the following; a printer, a scanner, a multifunction printer/scanner, a plotter, and a facsimile machine. In yet another embodiment, the imaging device peripheral is implemented as any one of the following; a stapler, a sorter, a collator, a hole punch, a laminator, a sheet folder, a stitching unit, a stacker, a sheet feeder (e.g., a fax input tray), an envelope feeder, etc.

At step 420 (FIG. 4), device specific identification data and the configuration status are provided to the imaging device. In one embodiment, device specific identification data and the configuration status are provided to the imaging device from the imaging device peripheral. In an example and referring to FIG. 1 above, device specific identification data and the configuration status are provided to printer 130 from printer peripheral 135. In another example and referring to FIG. 2 above, device specific identification data and the configuration status are provided to imaging device 210 from imaging device peripheral 250.

In another embodiment, device specific identification data includes information that will enable the imaging device peripheral to be identified, such as, for example the manufacturer and model number/serial number of the imaging device peripheral, available features of the imaging device peripheral, and the like. In this embodiment, the configuration status includes data relating to whether the imaging device peripheral has been configured. In an example, the configuration status includes information relating to whether the imaging device peripheral has been configured to operate with the imaging device. In another example, the configuration status includes information relating to whether the imaging device peripheral has been configured to operate with the imaging device, as well as other previously attached imaging device peripherals.

At step 430 (FIG. 4), configuration data is received to the imaging device peripheral from the imaging device when the configuration status indicates that the imaging device peripheral has not been configured. The configuration data enables the imaging device peripheral to operate with the imaging device.

In one embodiment, receiving configuration data to the imaging device peripheral from the imaging device when the configuration status indicates that the imaging device peripheral has not been configured includes receiving the device specific identification data and the configuration status from the imaging device peripheral that has not been configured to the imaging device, and producing a configuration data request at the imaging device based on the imaging device, the device specific identification data associated with the imaging device peripheral that has not been configured, and additional detected imaging device peripherals. In this embodiment, receiving configuration data to the imaging device peripheral from the imaging device when the configuration status indicates that the imaging device peripheral has not been configured further includes communicating the configuration data request to a configuration service provider, and providing the configuration data to the imaging device peripheral from the imaging device.

In another embodiment, producing a configuration data request at the imaging device based on (a) the imaging device, (b) the device specific identification data associated with the imaging device peripheral that has not been configured, and (c) additional detected imaging device peripherals, includes identifying the imaging device and detecting previously configured imaging device peripherals. In this embodiment, producing a configuration data request at the imaging device further includes polling the detected imaging device peripherals that have previously been configured with the imaging device to providing device specific identification data to the imaging device, and generating the configuration data request.

In yet another embodiment, communicating the configuration data request to a configuration service provider includes transmitting the configuration data request to the configuration service provider, and receiving the configuration data to the imaging device from the configuration service provider.

In another embodiment, receiving configuration data to the imaging device peripheral from the imaging device when the configuration status indicates that the imaging device peripheral has not been configured includes receiving the device specific identification data and the configuration status from the imaging device peripheral that has not been configured to the imaging device, and producing a configuration data request at the imaging device based on the imaging device, the device specific identification data associated with the imaging device peripheral that has not been configured, and additional detected imaging device peripherals. In this embodiment, receiving configuration data to the imaging device peripheral from the imaging device when the configuration status indicates that the imaging device peripheral has not been configured further includes accessing a removable storage media responsive to the configuration data request to obtain the configuration data, and providing the configuration data to the imaging device peripheral from the imaging device. Examples of removable storage media include a CD, a DVD, a floppy disk, a C3D, a DAT, a super-floppy, and the like.

In still another embodiment, producing a configuration data request at the imaging device based on the imaging device, the device specific identification data associated with the imaging device peripheral that has not been configured, and additional detected imaging device peripherals includes identifying the imaging device and detecting previously configured imaging device peripherals. In this embodiment, producing a configuration data request at the imaging device further includes polling the detected imaging device peripherals that have previously been configured with the imaging device to provide device specific identification data to the imaging device, and generating the configuration data request.

At step 440, the imaging device peripheral is configured for operation with the imaging device based on the received configuration data. In one embodiment, configuring the imaging device peripheral for operation with the imaging device based on the received configuration data includes receiving the configuration data to the imaging device peripheral and implementing the configuration data within the imaging device peripheral. In another example, and referring to FIG. 2 above, configuring imaging device peripheral 250 for operation with imaging device 210 based on the received configuration data includes receiving the configuration data to imaging device peripheral 250 and implementing the configuration data within imaging device peripheral 250.

At optional step 450 (FIG. 4), the detected imaging device peripheral is operated when the detected imaging device peripheral has been configured. In one embodiment, and following step 430, the detected imaging device peripheral is operated when the detected imaging device peripheral is determined to have been previously configured. In another embodiment, and following step 440, the detected imaging device peripheral is operated responsive to the previous configuration step.

At step 455, the method ends.

It is anticipated that the invention will be embodied in other specific forms, not specifically described, that do not depart from its spirit or essential characteristics. The described embodiments are to be considered in all respects only as illustrative and not restrictive, the scope of the invention being defined by the appended claims and equivalents thereof.

I claim:

1. A method of operating an imaging device to configure an imaging device peripheral, comprising:
detecting at least one imaging device peripheral;
determining if the at least one detected imaging device peripheral has been configured;
requesting configuration data from a configuration service provider when the at least one detected imaging device peripheral has not been configured, the configuration data enabling the imaging device peripheral to operate with the imaging device;
receiving the configuration data from the configuration service provider; and
configuring the imaging device peripheral for operation with the imaging device based on the received configuration data.

2. The method of claim 1, further comprising operating the detected imaging device peripheral when the detected imaging device peripheral has been configured.

3. The method of claim 1, wherein configuring the imaging device peripheral for operation with the imaging device based on the received configuration data comprises:
providing the received configuration data to the imaging device peripheral; and
implementing the configuration data within the imaging device peripheral.

4. The method of claim 1, wherein requesting configuration data from the configuration service provider when the at least one detected imaging device peripheral has not been configured, comprises:
identifying the imaging device;
polling additional detected imaging device peripherals that have previously been configured, the previously configured imaging device peripherals providing device specific identification data;
producing a configuration data request based on the identified imaging device, the at least one detected imaging device peripheral that has not been configured, and additional detected previously configured imaging device peripherals; and
communicating the configuration data request to the configuration service provider.

5. The method of claim 1, wherein the imaging device is selected from the group consisting of: a printer, a scanner, a multifunction printer/scanner, a plotter, and a facsimile machine.

6. The method of claim 1, wherein the imaging device peripheral is selected from the group consisting of: a stapler, a sorter, a collator, a hole punch, a sheet folder, a stitching unit, laminator, a stacker, a sheet feeder, and an envelope feeder.

7. A method of configuring an imaging device peripheral to operate with an imaging device, comprising:
receiving an identification request to the imaging device peripheral from the imaging device, the identification request including a request for device specific identification data and a configuration status;
providing the device specific identification data and the configuration status to the imaging device;
receiving configuration data to the imaging device peripheral from the imaging device when the configuration status indicates that the imaging device peripheral has not been configured, the configuration data enabling the imaging device peripheral to operate with the imaging device; and
configuring the imaging device peripheral for operation with the imaging device based on the received configuration data.

8. The method of claim 7, further comprising:
operating the configured imaging device peripheral.

9. The method of claim 7, wherein receiving configuration data to the imaging device peripheral from the imaging device when the configuration status indicates that the imaging device peripheral has not been configured, comprises:
receiving the device specific identification data and the configuration status from the imaging device peripheral that has not been configured to the imaging device;
producing a configuration data request at the imaging device based on the imaging device, the device specific identification data associated with the imaging device peripheral that has not been configured, and additional detected imaging device peripherals;
communicating the configuration data request to a configuration service provider; and
providing the configuration data to the imaging device peripheral from the imaging device.

10. The method of claim 9, wherein producing a configuration data request at the imaging device based on the imaging device, the device specific identification data associated with the imaging device peripheral that has not been configured, and additional detected imaging device peripherals, comprises:
identifying the imaging device;
detecting previously configured imaging device peripherals;
polling the detected imaging device peripherals that have previously been configured with the imaging device, the previously configured imaging device peripherals providing device specific identification data to the imaging device; and
generating the configuration data request.

11. The method of claim 9, wherein communicating the configuration data request to a configuration service provider, comprises:
transmitting the configuration data request to the configuration service provider; and
receiving the configuration data to the imaging device from the configuration service provider.

12. The method of claim 7, wherein receiving configuration data to the imaging device peripheral from the imaging device when the configuration status indicates that the imaging device peripheral has not been configured, comprises:
receiving the device specific identification data and the configuration status from the imaging device peripheral that has not been configured to the imaging device;
producing a configuration data request at the imaging device based on the imaging device, the device specific identification data associated with the imaging device peripheral that has not been configured, and additional detected imaging device peripherals;
accessing a removable storage media responsive to the configuration data request to obtain the configuration data; and
providing the configuration data to the imaging device peripheral from the imaging device.

13. The method of claim 12, wherein producing a configuration data request at the imaging device based on the imaging device, the device specific identification data associated with the imaging device peripheral that has not been configured, and additional detected imaging device peripherals, comprises:
identifying the imaging device;
detecting previously configured imaging device peripherals;
polling the detected imaging device peripherals that have previously been configured with the imaging device, the previously configured imaging device peripherals providing device specific identification data to the imaging device; and
generating the configuration data request.

14. The method of claim 12, wherein the removable storage media is selected from the group consisting of: a CD, a DVD, a floppy disk, a C3D, a DAT, and a super-floppy.

15. The method of claim 7, wherein the imaging device is selected from the group consisting of: a printer, a scanner, a multifunction printer/scanner, a plotter, and a facsimile machine.

16. The method of claim 7, wherein the imaging device peripheral is selected from the group consisting of: a stapler, a sorter, a collator, a hole punch, a sheet folder, a stitching unit, laminator, a stacker, a sheet feeder, and an envelope feeder.

17. A network configured to provide resource management, comprising:
a communication bus;
an imaging device;
at least one imaging device peripheral;
at least one processor; and
at least one computer readable memory device which is readable by the processor, the computer readable memory device including a series of computer executable steps configured to cause the processor to:
detect at least one imaging device peripheral;
determine if the at least one detected imaging device peripheral has been configured;
request configuration data from a configuration service provider when the at least one detected imaging device peripheral has not been configured, the configuration data enabling the imaging device peripheral to operate with the imaging device;
receive the configuration data from the configuration service provider; and
configure the imaging device peripheral for operation with the imaging device based on the received configuration data.

18. The network of claim 17, wherein the processor is co-located within the imaging device.

19. The network of claim 17, further comprising a series of computer executable steps configured to cause the processor to operate the detected imaging device peripheral when the detected imaging device peripheral has been configured.

20. The network of claim 17, wherein the computer executable steps configured to cause the processor to configure the imaging device peripheral for operation with the imaging device based on the received configuration data comprise a series of computer executable steps configured to cause the processor to:
provide the received configuration data to the imaging device peripheral; and
implement the configuration data within the imaging device peripheral.

21. The network of claim 17, wherein the computer executable steps configured to cause the processor to request configuration data from the configuration service provider when the at least one detected imaging device peripheral has not been configured comprise a series of computer executable steps configured to cause the processor to:
identify the imaging device;
poll additional detected imaging device peripherals that have previously been configured, the previously configured imaging device peripherals providing device specific identification data;
produce a configuration data request based on the identified imaging device, the at least one detected imaging device peripheral that has not been configured, and additional detected previously configured imaging device peripherals; and
communicate the configuration data request to the configuration service provider.

22. The network of claim 17, wherein the imaging device is selected from the group consisting of a printer, a scanner, a multifunction printer/scanner, a plotter, and a facsimile machine.

23. The network of claim 17, wherein the imaging device peripheral is selected from the group consisting of: a stapler, a sorter, a collator, a hole punch, a sheet folder, a stitching unit, laminator, a stacker, a sheet feeder, and an envelope feeder.

24. A computer readable medium storing a computer program to manage resources within a network, comprising:
computer readable code to detect at least one imaging device peripheral;
computer readable code to determine if the at least one detected imaging device peripheral has been configured;
computer readable code to request configuration data from a configuration service provider when the at least one detected imaging device peripheral has not been configured, the configuration data enabling the imaging device peripheral to operate with the imaging device;
computer readable code to direct the reception of configuration data from the configuration service provider; and
computer readable code to configure the imaging device peripheral for operation with the imaging device based on the received configuration data.

25. The computer readable medium of claim 24, further comprising computer readable code to operate the detected imaging device peripheral when the detected imaging device peripheral has been configured.

26. The computer readable medium of claim 24, wherein the computer readable code to configure the imaging device peripheral for operation with the imaging device based on the received configuration data comprises:
computer readable code to provide the received configuration data to the imaging device peripheral; and
computer readable code to implement the configuration data within the imaging device peripheral.

27. The computer readable medium of claim 24, wherein the computer readable code to request configuration data from the configuration service provider when the at least one detected imaging device peripheral has not been configured, comprises:
computer readable code to identify the imaging device;
computer readable code to poll additional detected imaging device peripherals that have previously been configured, the previously configured imaging device peripherals providing device specific identification data;
computer readable code to produce a configuration data request based on the identified imaging device, the at least one detected imaging device peripheral that has not been configured, and additional detected previously configured imaging device peripherals; and
computer readable code to communicate the configuration data request to the configuration service provider.

28. The computer readable medium of claim 24, wherein the imaging device is selected from the group consisting of: a printer, a scanner, a multifunction printer/scanner, a plotter, and a facsimile machine.

29. The computer readable medium of claim 24, wherein the imaging device peripheral is selected from the group consisting of: a stapler, a sorter, a collator, a hole punch, a sheet folder, a stitching unit, laminator, a stacker, a sheet feeder, and an envelope feeder.

30. A computer readable medium storing a computer program to configure resources within a network, comprising:
computer readable code to direct the reception of an identification request to an imaging device peripheral from an imaging device, the identification request including a request for device specific identification data and a configuration status;
computer readable code to provide the device specific identification data and the configuration status to the imaging device;
computer readable code to direct the reception of configuration data to the imaging device peripheral from the imaging device when the configuration status indicates that the imaging device peripheral has not been configured, the configuration data enabling the imaging device peripheral to operate with the imaging device; and
computer readable code to configure the imaging device peripheral for operation with the imaging device based on the received configuration data.

31. The computer readable medium of claim 30, further comprising: computer readable code to operate the configured imaging device peripheral.

32. The computer readable medium of claim 30, wherein the computer readable code to direct the reception of configuration data to the imaging device peripheral from the imaging device when the configuration status indicates that the imaging device peripheral has not been configured, comprises:
computer readable code to direct the reception of device specific identification data and the configuration status from the imaging device peripheral that has not been configured to the imaging device;
computer readable code to produce a configuration data request at the imaging device based on the imaging device, the device specific identification data associated with the imaging device peripheral that has not been configured, and additional detected imaging device peripherals;
computer readable code to communicate the configuration data request to a configuration service provider; and
computer readable code to provide the configuration data to the imaging device peripheral from the imaging device.

33. The computer readable medium of claim 32, wherein the computer readable code to produce a configuration data request at the imaging device based on the imaging device, the device specific identification data associated with the imaging device peripheral that has not been configured, and additional detected imaging device peripherals, comprises:
computer readable code to identify the imaging device;
computer readable code to detect previously configured imaging device peripherals;
computer readable code to poll the detected imaging device peripherals that have previously been configured with the imaging device, the previously configured imaging device peripherals providing device specific identification data to the imaging device; and
computer readable code to generate the configuration data request.

34. The computer readable medium of claim 32, wherein the computer readable code to communicate the configuration data request to a configuration service provider, comprises:
computer readable code to transmit the configuration data request to the configuration service provider; and
computer readable code to direct the reception of the configuration data to the imaging device from the configuration service provider.

35. The computer readable medium of claim 30, wherein the computer readable code to direct the reception of configuration data to the imaging device peripheral from the imaging device when the configuration status indicates that the imaging device peripheral has not been configured, comprises:
computer readable code to direct the reception of the device specific identification data and the configuration status from the imaging device peripheral that has not been configured to the imaging device;
computer readable code to produce a configuration data request at the imaging device based on the imaging device, the device specific identification data associated with the imaging device peripheral that has not been configured, and additional detected imaging device peripherals;
computer readable code to assess a removable storage media responsive to the configuration data request to obtain the configuration data; and
computer readable code to provide the configuration data to the imaging device peripheral from the imaging device.

36. The computer readable medium of claim 35, wherein the computer readable code to produce a configuration data request at the imaging device based on the imaging device, the device specific identification data associated with the imaging device peripheral that has not been configured, and additional detected imaging device peripherals, comprises:
computer readable code to identify the imaging device;
computer readable code to detect previously configured imaging device peripherals;
computer readable code to poll the detected imaging device peripherals that have previously been configured with the imaging device, the previously configured imaging device peripherals providing device specific identification data to the imaging device; and
computer readable code to generate the configuration data request.

37. The computer readable medium of claim 35, wherein the removable storage media is selected from the group consisting of: a CD, a DVD, a floppy disk, a C3D, a DAT, and a super-floppy.

38. The computer readable medium of claim 30, wherein the imaging device is selected from the group consisting of: a printer, a scanner, a multifunction printer/scanner, a plotter, and a facsimile machine.

39. The computer readable medium of claim 30, wherein the imaging device peripheral is selected from the group consisting of: a stapler, a sorter, a collator, a hole punch, a sheet folder, a stitching unit, laminator, a stacker, a sheet feeder, and an envelope feeder.

40. A system for operating an imaging device to configure an imaging device peripheral, comprising:
means for detecting at least one imaging device peripheral;
means for determining if the at least one detected imaging device peripheral has been configured;
means for requesting configuration data from a configuration service provider when the at least one detected imaging device peripheral has not been configured, the configuration data enabling the imaging device peripheral to operate with the imaging device;
means for receiving the configuration data from the configuration service provider; and
means for configuring the imaging device peripheral for operation with the imaging device based on the received configuration data.

41. The system of claim 40, further comprising means for operating the detected imaging device peripheral when the detected imaging device peripheral has been configured.
